(19) United States
(12) Patent Application Publication
(10) Pub. No.: US 2026/0356367 A1
(43) Pub. Date: Nov. 12, 2026

(54) Driving Assistance System and Driving Assistance Method for Lateral Guidance of a Vehicle

(71) Applicant: Bayerische Motoren Werke Aktiengesellschaft, Muenchen (DE)

(72) Inventor: Boris ISRAEL, Muenchen (DE)

(21) Appl. No.: 19/111,942

(22) PCT Filed: Aug. 31, 2023
(86) PCT No.: PCT/EP2023/073974

§ 371 Date: Mar. 14, 2025

(30) Foreign Application Priority Data
Sep. 16, 2022 (DE) 10 2022 123 774.5

(51) Int. Cl. B60W 30/18; B60W 50/14

(52) U.S. Cl. CPC B60W 30/18163; B60W 30/18145; B60W 50/14; B60W 2050/143; B60W 2540/20

(57) ABSTRACT

A driving assistance system comprises an actuation element for a direction indicator. The actuation element initiates an automatic lateral guidance process in the event of an active lateral guidance assistant when activated or triggered by a driver. At least one audio output module that is configured to: in the event of an active lateral guidance assistant, output a first sound signal if the automatic lateral driving process can be carried out, and output a second sound signal different from the first sound signal if the automatic lateral driving process cannot be carried out.

### BACKGROUND AND SUMMARY

The present disclosure relates to a driving assistance system for lateral guidance of a vehicle, a vehicle having such a driving assistance system, a driving assistance method for lateral guidance of a vehicle, and a storage medium for carrying out the driving assistance method. The present disclosure relates in particular to an acoustic indication for an activated lateral guidance assistant, such as a lane keeping assistant.

Driving assistance systems for automated driving are increasingly gaining importance. Automated driving can take place with various degrees of automation. Exemplary degrees of automation are assisted, semiautomated, conditionally automated, highly automated, or fully automated driving. The above-mentioned five degrees of automation correspond to SAE levels 1 to 5 of the norm SAE J3016 (SAE—Society of Automotive Engineering) according to the status of Apr. 30, 2021. In fully automated driving (SAE level 5), all aspects of the dynamic driving task can be carried out by the system under any roadway and environmental condition which can also be managed by a human driver.

One example of a driving assistance system is a lane changing assistant, which can carry out an automatic lane change. The lane changing assistant can be activated here by the driver and triggered as needed. Lane changing assistants are subject to specific functional restrictions, however, which are not immediately apparent to every driver. For example, if there is a lack of structural separation between an ego roadway and an oncoming roadway, often no automatic lane change can be carried out for reasons of safety. Further functional restrictions can be present in specific speed ranges and/or in the event of reduced free spaces on the lanes.

It can therefore occur that the lane changing assistant is active and is indicated as available in principle, for example, on an instrument cluster, but cannot be triggered due to the functional restrictions. The driver therefore does not immediately know whether the automatic lane change was successfully triggered and has to look at the instrument cluster, for example, to classify the situation correctly. Inconveniences result for the driver in this way, which can lead to a reduced acceptance of such driving assistance systems. Moreover, the driver has to look away from the road in order to correctly classify the situation, so that traffic safety is impaired.

It is an object of the present disclosure to specify a driving assistance system for lateral guidance of a vehicle, a vehicle having such a driving assistance system, a driving assistance method for lateral guidance of a vehicle, and a storage medium for carrying out the driving assistance method, which can clearly indicate a functional status of a driving assistance system. Moreover, it is an object of the present disclosure to improve an acceptance of driving assistance systems for lateral guidance and/or safety in road traffic.

This object is achieved by the subject matter described herein.

According to one embodiment, a driving assistance system for lateral guidance of a vehicle, in particular a motor vehicle, is specified. The driving assistance system comprises an actuating element for a directional indicator, wherein the actuating element is configured to initiate an automatic lateral guidance process in the case of an active lateral guidance assistant upon actuation or triggering by a driver; and at least one audio output module which is configured to output a first sound signal in the case of an active lateral guidance assistant if the automatic lateral guidance process is performable, and to output a second sound signal different from the first sound signal if the automatic lateral guidance process is not performable.

According to at least one embodiment, a sound signal is output based on whether or not the lateral guidance assistant was successfully triggered. For example, different sounds or sound sequences can be output. The driver thus hears immediately and without distraction from the vehicle guidance whether the lateral guidance assistant was successfully triggered. As a result, the functional status of the driving assistance system can be clearly indicated, by which an acceptance of driving assistance systems for lateral guidance and safety in road traffic can be improved.

The at least one audio output module preferably comprises one or more loudspeakers for outputting the first sound signal and the second sound signal.

The term “active lateral guidance assistant” relates to a general or fundamental activation or availability of the lateral guidance assistant, for example due to a user input by the driver, such as pressing a button or actuating a lever. In other words, the active lateral guidance assistant can correspond to a switched-on state of the lateral guidance assistant. In such an active state of the lateral guidance assistant, the driver can actuate the actuating element, whereupon in the ideal case the automatic lateral guidance process is started. Accordingly, the term “inactive lateral guidance assistant” relates to a switched-off state of the lateral guidance assistant, for example due to a user input by the driver, such as pressing a button or actuating a lever. In such an inactive state of the lateral guidance assistant, the driver can actuate the actuating element, whereupon the automatic lateral guidance process is not started, but rather the directional indicator is activated.

The lateral guidance assistant can thus be activated by the driver and triggered as needed. The automatic lateral guidance process may not be performable in specific situations, however. In particular, lateral guidance assistants can be subject to functional restrictions, which have the result that even in the case of an active lateral guidance assistant, performing an automatic lateral guidance process is not possible. For example, if there is a lack of structural separation between an ego roadway and an oncoming roadway, often an automatic lane change cannot be carried out for reasons of safety. Further functional restrictions can be present in specific speed ranges and/or in the case of reduced free spaces on the lanes.

Preferably, in the case of an active lateral guidance assistant, the directional indicator is triggered and the second sound signal is output if the automatic lateral guidance process is not performable. In other words, in the event of unsuccessful triggering of the automatic lateral guidance process by the driver, the directional indicator can be activated instead of the automatic lateral guidance process.

Preferably, the at least one audio output module is configured, upon an actuation of the actuating element by the driver, to output the second sound signal to indicate an activation of the directional indicator if the lateral guidance assistant is inactive. In other words, both in the case of an inactive lateral guidance assistant and actuation of the directional indicator and in the case of an active lateral guidance assistant and failed triggering of the automatic lateral guidance process, the same sound signal is output. The driver thus hears, without distraction from the vehicle guidance, whether, in the case of an active lateral guidance assistant, the automatic lateral guidance process or only the directional indicator was activated.

Preferably, the second sound signal is a turn signal sound, in particular a standard turn signal sound. In this case, the driver receives an acoustic notification in the form of the turn signal sound (i.e. the second sound signal) if, in the case of an active or inactive lateral guidance assistant, only the directional indicator was triggered, and a modified turn signal sound (i.e. the first sound signal) if, in the case of an active lateral guidance assistant, the automatic lateral guidance process and the directional indicator were triggered.

The actuating element, such as a turn signal lever, has a multiple function, namely actuating the directional indicator and triggering the automatic lateral guidance process. In particular, the automatic lateral guidance process can be triggered via a turn signal lever which is not provided exclusively for the lateral guidance assistant. Which of the functions is executed upon actuation of the actuating element is determined based on whether the lateral guidance assistant is active or inactive and whether, in the case of an active lateral guidance assistant, an automatic lateral guidance process is performable.

Preferably, the first sound signal comprises a first sound signal part and a second sound signal part different from the first sound signal part. The at least one audio output module can be configured to output the first sound signal part during a preparation phase of the automatic lateral guidance process and the second sound signal part during an actual performance of the automatic lateral guidance process or the automatic lateral guidance.

The preparation phase can be, for example, a search phase for a gap in the case of an automatic lane change. Performing the automatic lateral guidance process can correspond to actually performing the lane change. In this way, the driver can recognize easily which phase the automatic lateral guidance process is currently in.

Preferably, the at least one audio output module is configured to output the first sound signal until the automatic lateral guidance process is ended. The driver can therefore hear how long the automatic lateral guidance process is active and when it is ended or begun.

Preferably, the first sound signal is longer or shorter than the second sound signal.

Additionally or alternatively, the first sound signal can be louder or quieter than the second sound signal.

Additionally or alternatively, the first sound signal and the second sound signal can have at least partially different sound sequences.

Additionally or alternatively, the first sound signal can be an undertone sequence of the second sound signal. Alternatively, the first sound signal can correspond to the second sound signal with one or more additional sounds.

Additionally or alternatively, the first sound signal can be directed in a first spatial direction and the second sound signal can be directed in a second spatial direction different from the first spatial direction. For example, the first sound signal can come from the front in the vehicle and the second sound signal can come from the rear in the vehicle, so that the driver can distinguish the first sound signal from the second sound signal.

Preferably, the automatic lateral guidance process is selected from the group which comprises an automatic lane change and an automatic turnoff procedure, or which consists thereof.

According to at least one embodiment, a vehicle, in particular a motor vehicle, is specified. The vehicle comprises the driving assistance system according to the embodiments of the present disclosure.

The term vehicle comprises passenger vehicles, trucks, buses, caravans, motorcycles, etc. which are used to convey people, goods, etc. In particular, the term comprises motor vehicles for conveying people.

The driving assistance system is configured for automated driving, comprising or consisting of automatic lateral guidance.

The term “automated driving” is understood in the context of the document as driving with automated longitudinal and/or lateral guidance. Automated driving can be, for example, driving for a longer time on the freeway or driving for a limited time in the context of parking. The term “automated driving” comprises automated driving with an arbitrary degree of automation. Exemplary degrees of automation are assisted, semiautomated, conditionally automated, highly automated, or fully automated driving (each with increasing degree of automation). The above-mentioned five degrees of automation correspond to SAE levels 1 to 5 of the norm SAE J3016 (SAE—Society of Automotive Engineering) according to the status of Apr. 30, 2021.

In assisted driving (SAE level 1), the system carries out longitudinal or lateral guidance in specific driving situations. In semiautomated driving (SAE level 2), the system takes over the longitudinal and lateral guidance in specific driving situations, wherein the driver has to continuously monitor the system as in assisted driving. In conditionally automated driving (SAE level 3), the system takes over the longitudinal and lateral guidance in specific driving situations without the driver having to continuously monitor the system; however, the driver has to be capable within a certain time of taking over the vehicle guidance upon request by the system. In highly automated driving (SAE level 4), the system takes over the vehicle guidance in specific driving situations, even if the driver does not react to a request to intervene, so that the driver is omitted as a fallback level. In fully automated driving (SAE level 5), all aspects of the dynamic driving task can be carried out by the system under any roadway and environmental condition, which can also be managed by a human driver.

In addition, the term “at least semiautomated driving or maneuvering” is also understood in the context of the document as semiautomated, conditionally automated, highly automated, or fully automated driving. In other words, the term “at least semiautomated driving” is thus understood as a degree of automation from SAE level 2 inclusive.

The driving assistance system of the present disclosure corresponds to a degree of automation in which automatic lateral guidance is possible upon a user input by the driver. Such a degree of automation can be, for example, SAE level 2.

According to at least one embodiment, a driving assistance method for a vehicle, in particular a motor vehicle, is specified. The driving assistance method comprises detecting an actuation of an actuating element for a directional indicator by a driver; if a lateral guidance assistant is active and as a reaction to the actuation of the actuating element, outputting a first sound signal if an automatic lateral guidance process is performable, or outputting a second sound signal different from the first sound signal if the automatic lateral guidance process is not performable; and if the lateral guidance assistant is inactive and as a reaction to the actuation of the actuating element, outputting the second sound signal to indicate an activation of the directional indicator.

The driving assistance method can implement the aspects of the driving assistance system described in this document for a vehicle.

According to at least one embodiment, a software (SW) program is specified. The SW program can be configured to be executed on one or more processors and to thus carry out the driving assistance method described in this document for a vehicle.

According to at least one embodiment, a storage medium is specified. The storage medium can comprise an SW program which is configured to be executed on one or more processors and to thus carry out the driving assistance method described in this document for a vehicle.

According to at least one embodiment, software having program code is specified. The software is configured to perform the driving assistance method for a vehicle when the software runs on one or more software-controlled devices.

According to at least one embodiment, a system for driver monitoring is specified. The system comprises one or more processors; and at least one memory which is connected to the one or more processors and contains instructions which can be executed by the one or more processors in order to carry out the driving assistance method described in this document for a vehicle.

A processor or a processor module is a programmable arithmetic unit, thus a machine or an electronic circuit, which controls other elements according to transferred commands and propels an algorithm (process).

Exemplary embodiments of the disclosure are shown in the figures and will be described in more detail hereinafter.

### BRIEF DESCRIPTION OF THE DRAWINGS

FIG. 1 schematically shows a vehicle having a driving assistance system according to embodiments of the present disclosure,

FIG. 2A schematically shows a detail view of the driving assistance system according to embodiments of the present disclosure,

FIG. 2B schematically shows different sound signals according to embodiments of the present disclosure,

FIG. 3 schematically shows a performable lane change according to embodiments of the present disclosure,

FIG. 4 schematically shows a non-performable lane change according to embodiments of the present disclosure, and

FIG. 5 shows a flow chart of a driving assistance method according to embodiments of the present disclosure.

### DETAILED DESCRIPTION OF THE DRAWINGS

Identical reference signs are used hereinafter for identical and identically-acting elements if not indicated otherwise.

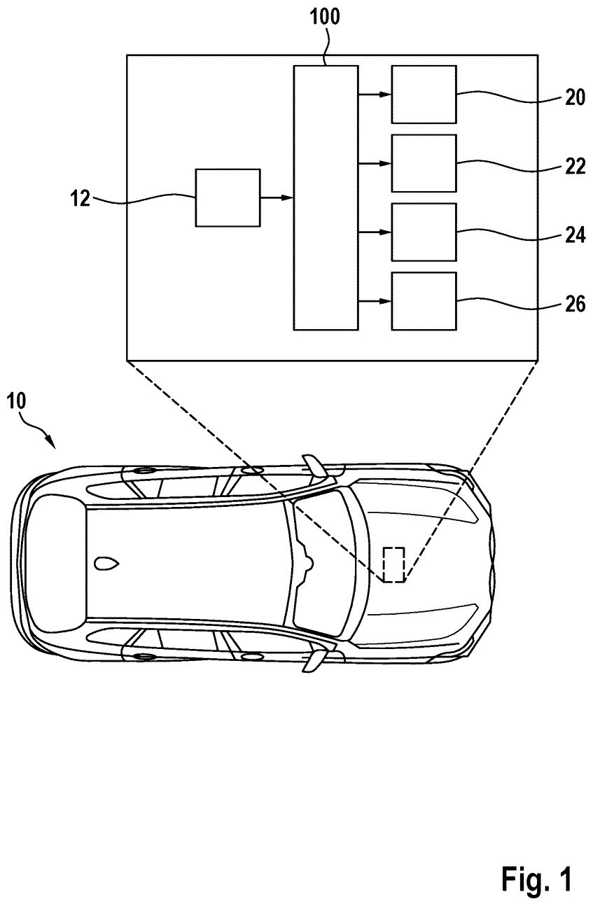

FIG. 1 schematically shows a vehicle 10 having a driving assistance system 100 according to embodiments of the present disclosure.

The driving assistance system 100 is configured for automated driving. In automated driving according to the embodiments of the present disclosure, the lateral guidance (and optionally the longitudinal guidance) of the vehicle 10 takes place automatically. The driving assistance system 100 thus takes over the vehicle guidance. For this purpose, the driving assistance system 100 controls the steering 26 and optionally the drive 20, the transmission 22, and the hydraulic service brake 24 via intermediate units (not shown).

To plan and perform the automated driving, surroundings information of a surroundings sensor system, which observes the vehicle surroundings, is accepted by the driving assistance system 100. In particular, the vehicle can comprise at least one surroundings sensor 12 which is configured to record surroundings data that specify the vehicle surroundings. The at least one surroundings sensor 12 can comprise, for example, one or more LiDAR systems, one or more radar systems, one or more laser scanners, one or more ultrasonic sensors, and/or one or more cameras.

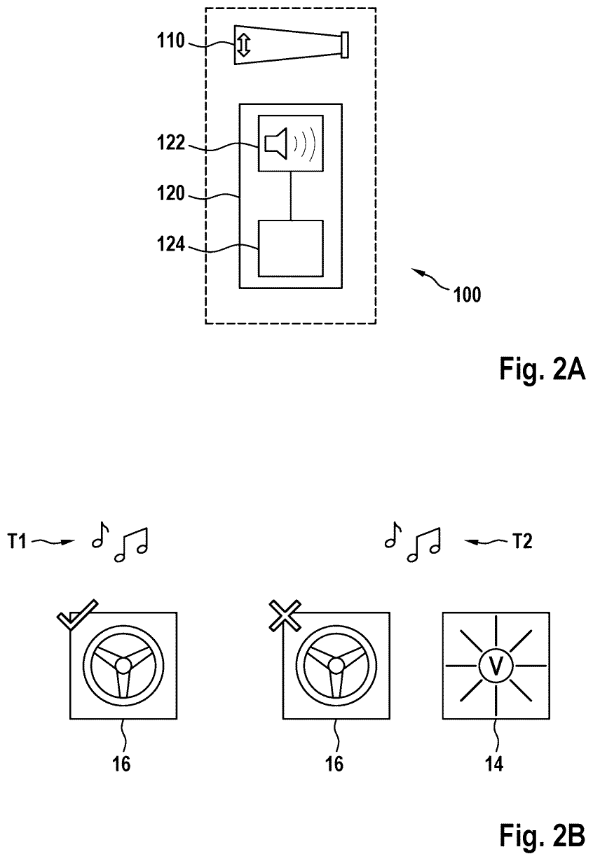

FIG. 2A schematically shows a detail view of the driving assistance system 100 according to embodiments of the present disclosure. FIG. 2B schematically shows different sound signals T1, T2 according to embodiments of the present disclosure.

The driving assistance system 100 of the present disclosure comprises (or is) a lateral guidance assistant 16 or can implement the functionalities of a lateral guidance assistant 16 by performing automated driving.

The driving assistance system 100 comprises an actuating element 110 for a directional indicator 14, wherein the actuating element 110 is configured to initiate an automatic lateral guidance process in the case of an active lateral guidance assistant 16 upon actuation or triggering by a driver; and at least one audio output module 120, which is configured in the case of an active lateral guidance assistant 16 to output a first sound signal T1 if the automatic lateral guidance process is performable and to output a second sound signal T2 different from the first sound signal T1 if the automatic lateral guidance process is not performable.

The actuating element 110 can be a turn signal lever and can have a multiple function, namely activating the directional indicator 14 and triggering the automatic lateral guidance process.

The at least one audio output module 120 can comprise one or more loudspeakers 122 for outputting the first sound signal T1 and the second sound signal T2. The at least one audio output module 120 can furthermore comprise a control module 124, which is configured to control the audio output of the at least one audio output module 120, in particular the output of the first sound signal T1 and the second sound signal T2.

The lateral guidance assistant 16 can be activated by the driver and can be triggered if needed by actuating the actuating element 110. If the driver triggers the actuating element 110 in the case of an active lateral guidance assistant 16 and the automatic lateral guidance process is performable, the at least one audio output module 120 outputs the first sound signal T1. If the driver triggers the actuating element 110 in the case of an active lateral guidance system 16 and the automatic lateral guidance process is not performable, the at least one audio output module 120 outputs the second sound signal T2. If the driver actuates the actuating element 110 in the case of an inactive lateral guidance assistant 16, the at least one audio output module 120 outputs the second sound signal T2 to indicate an activation of the directional indicator 14.

Therefore, the same sound signal T2 can be output both in the case of an inactive lateral guidance assistant 16 and actuation of the directional indicator 14 and also in the case of an active lateral guidance assistant 16 and failed triggering of the automatic lateral guidance process. The driver thus hears, without distraction from the vehicle guidance, whether, in the case of an active lateral guidance assistant 16, the automatic lateral guidance process or only the directional indicator 14 was activated.

The automatic lateral guidance process can be, for example, an automatic lane change or an automatic turnoff process.

The second sound signal T2 can be a standard turn signal sound. In this case, the driver receives an acoustic notification in the form of the turn signal sound (i.e. the second sound signal T2) if, in the case of an active or inactive lateral guidance assistant 16, only the directional indicator 14 was triggered, and a modified turn signal sound (i.e. the first sound signal T1) if, in the case of an active lateral guidance assistant 16, the automatic lateral guidance process and the directional indicator 14 were triggered.

In some embodiments, the first sound signal T1 comprises a first sound signal part and a second sound signal part different from the first sound signal part. The at least one audio output module 120 can be configured to output the first sound signal part during a preparation phase of the automatic lateral guidance process and the second sound signal part during a performance of the automatic lateral guidance process or the automatic lateral guidance.

The preparation phase can be, for example, a search phase for a gap during an automatic lane change. The performance of the automatic lateral guidance process can correspond to an actual performance of the lane change. In this way, the driver can recognize easily in which phase the automatic lateral guidance process is currently.

The first sound signal T1 and the second sound signal T2 are configured differently such that it is possible for the driver to distinguish the two sound signals from one another. For example, the first sound signal T1 can be longer or shorter than the second sound signal T2. Additionally or alternatively, the first sound signal T1 can be louder or quieter than the second sound signal T2. Additionally or alternatively, the first sound signal T1 and the second sound signal T2 can have at least partially different sound sequences. Additionally or alternatively, the first sound signal T1 can be an undertone sequence of the second sound signal T2. Alternatively, the first sound signal T1 can correspond to the second sound signal T2 with one or more additional sounds. Additionally or alternatively, the first sound signal T1 can be directed in a first spatial direction and the second sound signal T2 can be directed in a second spatial direction different from the first spatial direction. For example, the first sound signal T1 can come from the front in the vehicle, and the second sound signal T2 can come from the rear in the vehicle, so that the driver can distinguish the first sound signal T1 from the second sound signal T2.

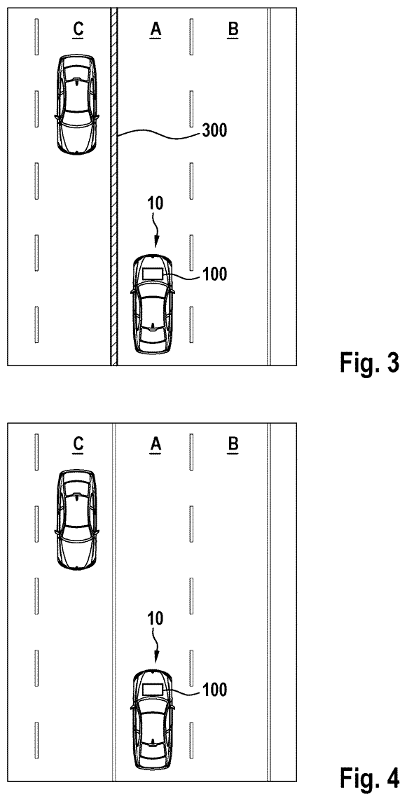

FIG. 3 schematically shows a performable lane change according to embodiments of the present disclosure. FIG. 4 schematically shows a non-performable lane change according to embodiments of the present disclosure.

The lateral guidance assistant can be activated by the driver and triggered as needed. The automatic lateral guidance process may not be performable in certain situations, however. In particular, lateral guidance assistants can be subject to functional restrictions which have the result that performing an automatic lateral guidance process is not possible even in the case of an active lateral guidance assistant. For example, in case of a lack of structural separation between an ego roadway A and an oncoming roadway C, no automatic lane change can often be performed from an ego roadway A to an adjacent lane B for reasons of safety.

In the example of FIG. 3, a structural separation 300 is present between the ego roadway A and the oncoming roadway C, so that a lane change is possible. In the example of FIG. 4, in contrast, no structural separation 300 is present between the ego roadway A and the oncoming roadway C, so that no lane change is possible.

Further functional restrictions which do not permit the performance of an automatic lane change even in the case of an active lane change assistant can be present in specific speed ranges and/or in the case of reduced free spaces on the lanes.

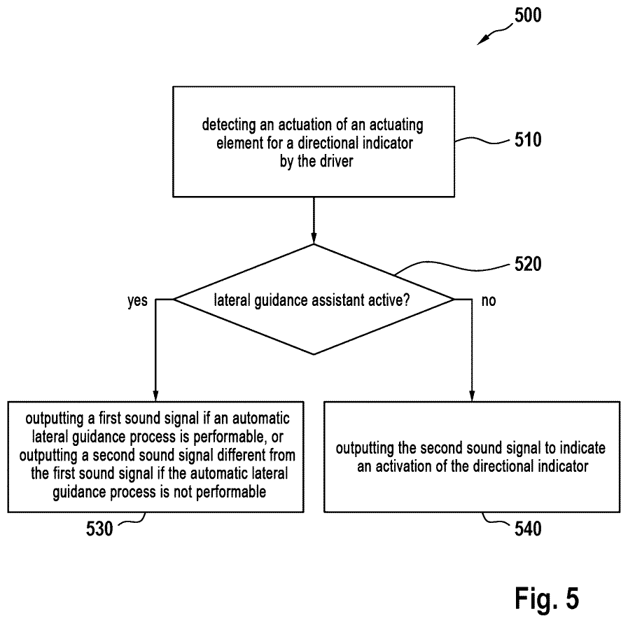

FIG. 5 shows a flow chart of a driving assistance method 500 according to embodiments of the present disclosure. The driving assistance method 500 can be implemented by corresponding software which is executable by one or more processors (such as a CPU).

The driving assistance method 500 comprises, in block 510, detecting an actuation of an actuating element for a directional indicator by a driver. If it is determined in block 520 that a lateral guidance assistant is active, and as a reaction to the actuation of the actuating element in block 510, the driving assistance method 500 comprises, in block 530, outputting a first sound signal if an automatic lateral guidance process is performable, or outputting a second sound signal different from the first sound signal if the automatic lateral guidance process is not performable. If it is determined in block 520 that the lateral guidance assistant is inactive, and as a reaction to the actuation of the actuating element in block 510, the driving assistance method 500 comprises, in block 540, outputting the second sound signal to indicate an activation of the directional indicator.

According to the invention, a sound signal is output based on whether or not the lateral guidance assistant was successfully triggered. For example, different sounds or sound sequences can be output. The driver thus hears immediately and without distraction from the vehicle guidance whether the lateral guidance assistant was successfully triggered. As a result, the functional status of the driving assistance system can be clearly indicated, by which an acceptance of driving assistance systems for lateral guidance and safety in road traffic can be improved.

Although the invention was illustrated and explained in more detail by preferred exemplary embodiments, the invention is not restricted by the disclosed examples and other variations can be derived therefrom by a person skilled in the art without leaving the scope of protection of the invention. It is therefore clear that a plurality of possible variations exists. It is also clear that embodiments mentioned by way of example actually only represent examples, which are not to be interpreted in any way as a limitation of, for example, the scope of protection, the possible applications, or the configuration of the invention. Rather, the preceding description and the description of the figures make a person skilled in the art capable of specifically implementing the exemplary embodiments, wherein a person skilled in the art aware of the disclosed concept of the invention can perform a variety of changes, for example with respect to the function or the arrangement of individual elements mentioned in an exemplary embodiment, without leaving the scope of protection defined by the claims and their legal equivalents, such as more extensive explanations in the description.

1-10. (canceled)

11. A driving assistance system for lateral guidance of a vehicle, comprising:
an actuating element for a directional indicator, wherein the actuating element is configured to initiate an automatic lateral guidance process if a lateral guidance assistant is active upon an actuation by a driver; and
at least one audio output module, which is configured to:
output a first sound signal if the automatic lateral guidance process is performable and the lateral guidance assistant is active, and
output a second sound signal different from the first sound signal if the automatic lateral guidance process is not performable.

12. The driving assistance system of claim 11, wherein the at least one audio output module is configured, upon an actuation of the actuating element by the driver, to output the second sound signal to indicate an activation of the directional indicator if the lateral guidance assistant is inactive.

13. The driving assistance system of claim 11, wherein:
the second sound signal is a standard turn signal sound; and/or
the actuating element is a turn signal lever having multiple functions.

14. The driving assistance system of claim 11,
wherein the first sound signal comprises a first sound signal part and a second sound signal part different from the first sound signal part, and
wherein the at least one audio output module is configured to output the first sound signal part during a preparation phase of the automatic lateral guidance process and the second sound signal part during a performance of the automatic lateral guidance process.

15. The driving assistance system of claim 11, wherein the at least one audio output module is configured to output the first sound signal until the automatic lateral guidance process is ended.

16. The driving assistance system of claim 11, wherein:
the first sound signal is longer or shorter than the second sound signal; and/or
the first sound signal is louder or quieter than the second sound signal; and/or
the first sound signal and the second sound signal have at least partially different sound sequences; and/or
the first sound signal is an undertone sequence of the second sound signal or corresponds to the second sound signal with one or more additional sounds; and/or
the first sound signal is directed in a first spatial direction and the second sound signal is directed in a second spatial direction different from the first spatial direction.

17. The driving assistance system of claim 11, wherein the automatic lateral guidance process is selected from the group which consists of an automatic lane change and an automatic turnoff process.

18. A motor vehicle comprising the driving assistance system of claim 11.

19. A driving assistance method for a vehicle, comprising:
detecting an actuation of an actuating element for a directional indicator by a driver;
if a lateral guidance assistant is active and in response to the actuation of the actuating element, outputting:
a first sound signal if an automatic lateral guidance process is performable, and
a second sound signal different from the first sound signal if the automatic lateral guidance process is not performable; and
if the lateral guidance assistant is inactive and in response to the actuation of the actuating element: outputting the second sound signal to indicate an activation of the directional indicator.

20. A non-transitory computer readable storage medium storing instructions that when carried out by one or more processors causes the execution of the driving assistance method of claim 19.
